(19) United States
(12) Patent Application Publication
(10) Pub. No.: US 2010/0127437 A1
(43) Pub. Date: May 27, 2010

(54) Tolerance Eliminating Assembly Retainer

(75) Inventors: Christopher D. Stevens, Belmont, NH (US); David A. Mauceri, Londonderry, NH (US); Mickey L. Love, Londonderry, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/323,028

(22) Filed: Nov. 25, 2008

(51) Int. Cl. F16F 5/00; F16F 7/00

(52) U.S. Cl. 267/64.11; 267/220

(57) ABSTRACT

A jounce bumper assembly is provided including a retainer to secure a dust shield and a jounce bumper to a top mount. The retainer has a base portion adapted to engage an end of the jounce bumper. The retainer further includes a retainer clip adapted to retain mating surfaces of the dust shield and top mount in tension thereby eliminating or reducing noise and loose assembly due to tolerance stack-up of the jounce bumper assembly.

### FIELD

The present disclosure relates to suspension systems for motor vehicles, and more particularly to a tolerance eliminating assembly retainer for use in a jounce bumper assembly in a suspension system of a motor vehicle.

### BACKGROUND

This section provides background information related to the present disclosure which is not necessarily prior art.

Jounce bumper assemblies may be used in suspension systems of motor vehicles. Such assemblies may require multiple components to be secured together. Due to variations in the manufacturing process and the high cost to produce components of exact dimensions, each individual finished component may not be the ideal dimensions according to design. If the dimensions of the component fall within a range of an allowed size difference, they may be within an acceptable dimensional tolerance and may be used in the assemblies. While a small dimensional difference in one component may not noticeably affect the assembly, the total dimensional difference that may result from multiple components of varying dimensional tolerances can lead to unwanted noise or loose assembly of the components.

### SUMMARY

The present invention provides a retainer for a jounce bumper assembly which eliminates noise and loose assembly of components by eliminating the total dimensional variation, or tolerance stack-up, of multiple components in the assembly. The retainer has a cavity to retain an end of the jounce bumper. The retainer also has distinctive interface clips to secure itself and the dust shield to a top mount of a motor vehicle. Thus, the retainer provides a unique way to securely attach the jounce bumper and dust shield to the top mount of a motor vehicle.

Due to the elastic properties of the interface clip, components of the assembly can be easily connected. Due to the tensile properties of the interface clip, once components are connected, the components are kept in tension and securely held throughout the tolerance range of the component dimensions. By securing the jounce bumper assembly in such a fashion, the retainer can reduce or eliminate loose assembly and noise between components due to tolerance stack-up. Use of the present novel retainer will also decrease manufacturing costs, as the retainer will allow for more lenient tolerance ranges of the various components in the assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a jounce bumper assembly constructed according to the principles of the present disclosure;

FIG. 2 is a perspective view of a retainer of a jounce bumper assembly according to the principles of the present disclosure;

FIG. 3 is a cross-sectional view of the retainer shown in FIG. 2;

FIG. 4 is a more detailed view of a retainer clip of FIG. 3; and

FIG. 5 is a partial cross-sectional view illustrating an alternative retainer engaged with a jounce bumper and a dust boot according to the principles of the present disclosure.

### DETAILED DESCRIPTION

The following description of the preferred embodiment(s) is merely exemplary in nature and is in no way intended to limit the invention, its application, or uses.

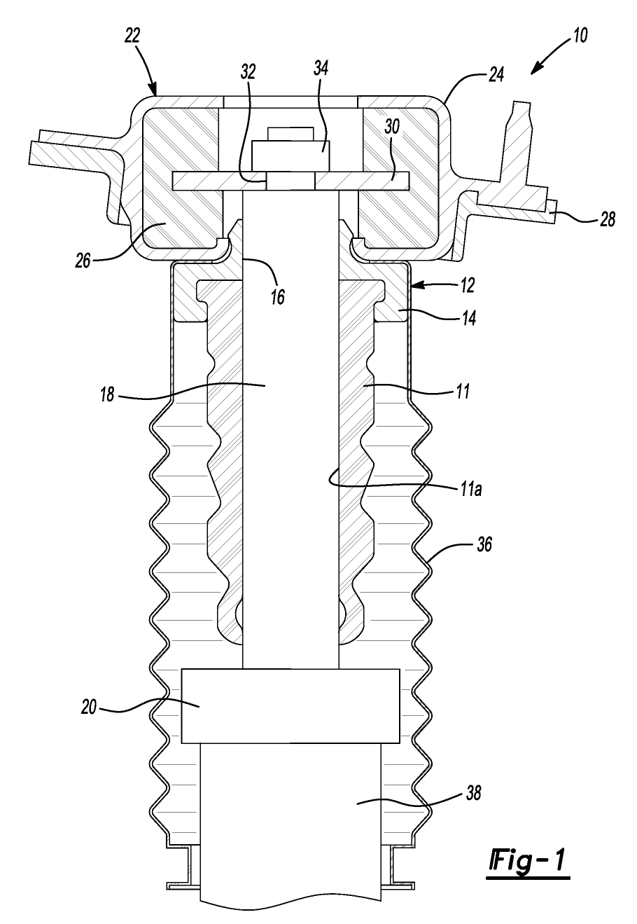

With reference to FIG. 1, a jounce bumper assembly 10 is shown. The jounce bumper assembly 10 includes a jounce bumper 11 and a retainer 12. Retainer 12 has a generally cylindrical base portion 14 with a central aperture 16 to receive a piston rod 18. It should be noted that retainer 12 may have any suitable geometry and is not limited to a cylindrical base portion. Piston rod 18 extends through a striker cap 20, through an aperture 11a in jounce bumper 11 and through aperture 16 of retainer 12 into a top mount 22 of a motor vehicle.

The top mount 22 includes a metal housing 24, an elastomeric body 26, a spring isolator 28 and a metal washer insert 30. An aperture in the metal insert 30 receives a necked down portion 32 of piston rod 18. Necked down portion 32 can be secured to metal insert 30 by nut 34.

Dust shield 36 extends from the bottom of top mount 22 to shock absorber body 38 that interfaces with striker cap 20. Dust shield 36 may be slip fit or clamped to shock absorber body 38 and prevents debris from getting into assembly 10.

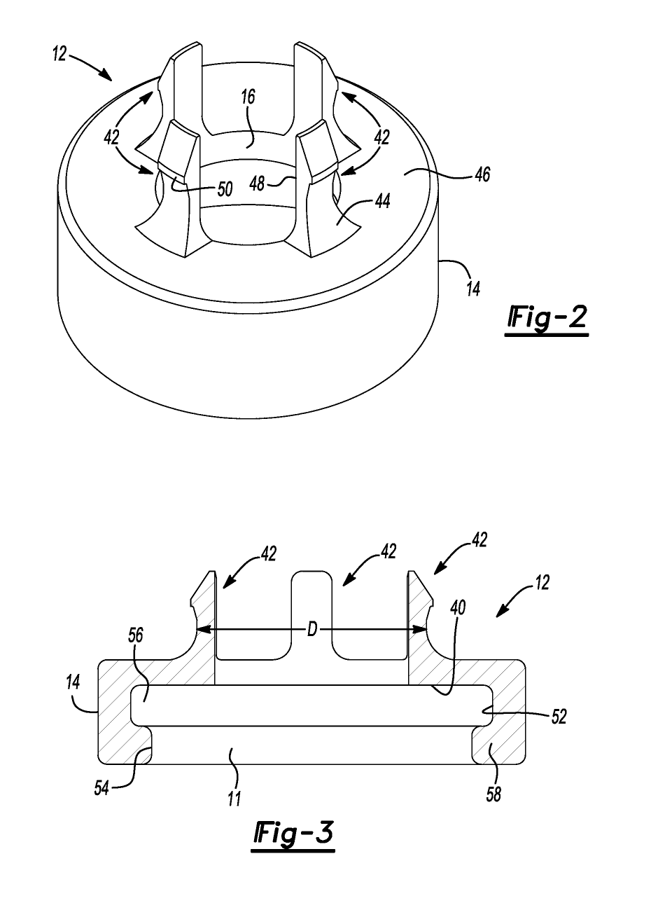

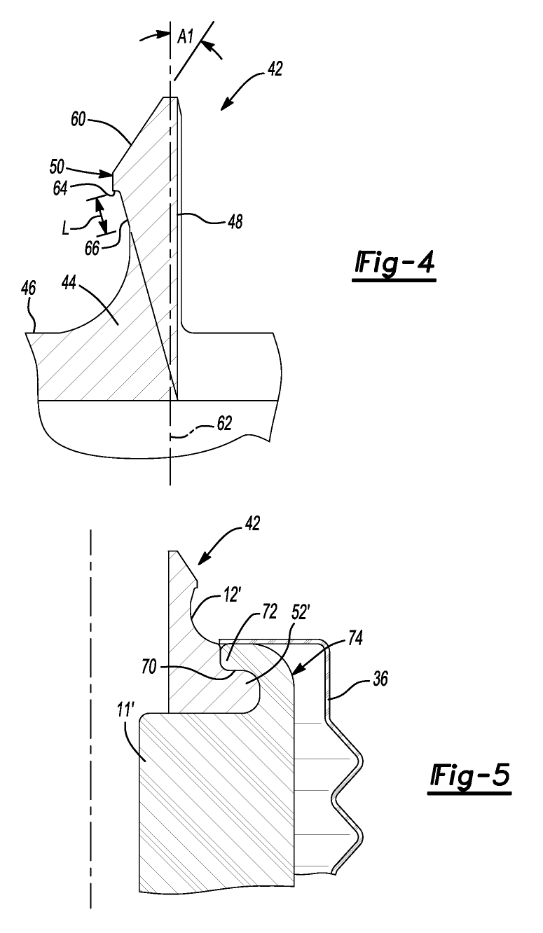

With further reference to FIG. 2, the retainer 12 has a generally cylindrical base portion 14 and a plurality of retainer interface clips 42 extending from the base portion 14 adjacent aperture 16. The retainer 12 can be formed as a unitary one-piece member from an engineering plastic material. As shown in FIG. 4, retainer clips 42 each include a base 44 coupled to a top surface 46 of base portion 14, a leg 48 extending from the base 44 and extending axially from top surface 46, and a retaining projection 50 extending radially outward a distal end of leg 48.

With further reference to FIG. 3, base portion 14 of retainer 12 defines a cavity 40. Cavity 40 includes a large diameter portion 52 at an innermost end and a small diameter portion 54. Large diameter portion 52 is adapted to accept a flange 56 on a male end of jounce bumper 11 and is retained in cavity 40 by a shoulder 58. As shown in FIG. 5, the retainer 12′ can alternatively be provided with a radially protruding flange 52′ on an outer surface that is adapted to be supported in a cavity 70 by a flange 72 in a female end 74 of a jounce bumper 11′.

With further reference to FIG. 4, projection 50 includes an outboard portion 60 angled outward from a longitudinal axis 62 of leg 48 and an inboard portion 64 angled outward from an axis perpendicular to axis 62. A contact portion 66 is adjacent the inboard portion 64. Outboard portion 60 is adapted to reduce the force needed to insert the clips 42 into the top mount 22. The angle of outboard portion 60 allows a dust shield 36 or top mount 22 to slide into a seated position on contact portion 66. Inboard portion 64 is adapted to increase the amount of force needed to disassemble dust shield 36 and top mount 22 from the retainer clip 42 once seated against contact portion 66. The vertical length L of contact portion 66 can be greater or equal to the tolerance stack-up in the assembly.

According to a preferred embodiment, one or more retainer clips 42 can be coupled to top surface 46 at selected intervals around aperture 16 with projection 50 extending away from piston rod 18. In the case of a single clip, the clip would be a continuous solid flexible ring. The contact portion 66 of each retainer clip 42 defines a contact face diameter D around aperture 16, which is larger than the mating surface diameter of top mount 22, thus creating constant tension between the contact portion 66 and the mating surface diameters. Outboard portion 60 can be angled A1 outward between 5 and 45 degrees from the longitudinal axis 62. Inboard portion 64 can be angled outward between 5 and 45 degrees from an axis perpendicular to axis 62. Contact portion 66 can be angled between 5 and 45 degrees outward from the longitudinal axis 62. The angles of the outboard portion 60, inboard portion 64 and contact portion 66 can be selected for a specific application based upon tolerance stack-ups.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A retaining apparatus for a jounce bumper assembly comprising:
a retainer having a base portion with an aperture to accept a piston rod, said base portion defining a cavity adapted to retain a jounce bumper; and
a plurality of retainer clips extending from a top surface of said base portion, wherein said retainer clips are adapted to secure a jounce bumper to a top mount.

2. The apparatus of claim 1, wherein said retainer clips further comprises a base, a leg attached to said base extending axially from said top surface of said base portion and a retaining projection extending radially outward from said leg.

3. The apparatus of claim 2, wherein said retaining projection has an outboard portion angled outward from a longitudinal axis of said leg to decrease assembly force and an inboard portion angled outward relative to an axis perpendicular to said longitudinal axis of said leg to increase disassembly force.

4. The apparatus of claim 1, wherein said retainer clips include a contact portion having a vertical length equal to or greater than a tolerance stack-up in said jounce bumper assembly.

5. The apparatus of claim 4, wherein said contact portion defines a contact face diameter, said contact face diameter being larger than an interface diameter of said top mount to be engaged by said retaining clips.

6. The apparatus of claim 1, wherein said cavity of said base portion includes a large diameter inner portion adapted to accept a flange on a male end of said jounce bumper and a relatively smaller diameter outer portion adjacent said large diameter defining a shoulder of said base portion adapted to retain said end of said jounce bumper within said cavity.

7. The apparatus of claim 3, wherein said outboard end of said retaining projection is angled outward between 5 and 45 degrees from said longitudinal axis of said leg.

8. The apparatus of claim 3, wherein said inboard end of said retaining projection is angled outward between 5 and 45 degrees from said axis perpendicular to said longitudinal axis of said leg.

9. The apparatus of claim 4, wherein said contact portion is angled outward between 5 and 45 degrees from a longitudinal axis of said leg.

10. A retaining apparatus for a jounce bumper assembly comprising:
a retainer having a base portion with an aperture to accept a piston rod, said base portion defining a cavity adapted to retain a jounce bumper; and
a plurality of retainer clips extending from a top surface of said base portion, wherein said retainer clips are adapted to secure a jounce bumper to a top mount.

11. The apparatus of claim 10, wherein said retainer clips further comprise a base, a leg attached to said base extending axially from said top surface of said base portion and a retaining projection extending radially outward from said leg.

12. The apparatus of claim 11, wherein said retaining projection has an outboard portion angled outward from a longitudinal axis of said leg to decrease assembly force and an inboard portion angled outward relative to an axis perpendicular to said longitudinal axis of said leg to increase disassembly force.

13. The apparatus of claim 10, wherein said retainer clips include a contact portion having a vertical length equal to or greater than a tolerance stack-up in said jounce bumper assembly.

14. A vehicle suspension apparatus comprising:
a piston rod extending through a striker cap;
a top mount having housing, an elastomeric body and an insert, said insert having an aperture to accept an end of said piston rod;
a dust shield having a first end in proximity to said top mount and a second end in proximity to a shock absorber body;
a jounce bumper having an aperture therethrough to accept said piston rod; and
a retainer having a base portion with an aperture to accept said piston rod, said base portion adapted to engage said jounce bumper and a plurality of retainer clips extending from a top surface of said base portion, wherein said retainer clips are adapted to secure said dust shield and said jounce bumper to said top mount.

15. The vehicle suspension apparatus according to claim 14, wherein said retainer clips each further comprise a base, a leg attached to said base extending axially from said top surface of said base portion and a retaining projection extending radially outward from said leg.

16. The vehicle suspension apparatus according to claim 15, wherein said retaining projection has an outboard portion angled outward from a longitudinal axis of said leg to decrease assembly force and an inboard portion angled outward relative to an axis perpendicular to said longitudinal axis of said leg to increase disassembly force.

17. The vehicle suspension apparatus according to claim 14, wherein said retainer clips each include a contact portion having a vertical length equal to or greater than a tolerance stack-up in said jounce bumper assembly.

18. The vehicle suspension apparatus according to claim 17, wherein said contact portion defines a contact face diameter, said contact face diameter being larger than an interface diameter of said top mount to be engaged by said retaining clips.

19. The vehicle suspension apparatus according to claim 14, wherein said base portion includes a cavity having a large diameter inner portion accepting a flange on a male end of said jounce bumper and a relatively smaller diameter outer portion adjacent said large diameter inner portion and defining a shoulder of said base portion retaining said end of said jounce bumper within said cavity.

20. The vehicle suspension apparatus according to claim 14, wherein said base portion includes a radial projection adapted to be received in a cavity in a female end of said jounce bumper.
